(19) United States
(12) Patent Application Publication
(10) Pub. No.: US 2012/0026197 A1
(43) Pub. Date: Feb. 2, 2012

(54) Method and Apparatus for Viewing Content on a Mobile Computing Device

(75) Inventor: Xintian Li, Cupertino, CA (US)

(73) Assignee: QUALCOMM INNOVATION CENTER, INC., San Diego, CA (US)

(21) Appl. No.: 12/844,393

(22) Filed: Jul. 27, 2010

(51) Int. Cl. G09G 5/00

(52) U.S. Cl. 345/650

(57) ABSTRACT

Methods and apparatus for changing the display of content on a mobile computing device are disclosed. In one embodiment, a non-transitory, tangible computer readable storage medium, encoded with processor readable instructions to perform a method of changing a content display on a mobile computing device screen comprises operatively receiving and processing a first signal comprising visual content and displaying at least a portion of the visual content on screen. In additional a second signal is provided from at least one sensor and the mobile computing device is subsequently moved, the second signal is processed and the display of the at least a portion of the visual content on the mobile computing device screen is changed relative to the movement of the device.

### FIELD OF THE INVENTION

The present invention relates to mobile computing devices. In particular, but not by way of limitation, the present invention relates to apparatus and methods for viewing content on mobile computing devices.

### BACKGROUND OF THE INVENTION

Viewing content such as, but not limited to, web pages on mobile computing devices has become increasingly ubiquitous amongst mobile computing device users. Oftentimes content such as, but not limited to, web pages, are viewed when traveling in a vehicle such as an automobile. During these times, and others, it may be difficult for the user of the device to hold the device steady as the vehicle travels. The continual movement of the device may cause the user to cease viewing the content as the user's eyes may become tired, or due to other physical ailments that the movement of the viewed content may cause. Mobile computing device users may therefore cease or limit the amount of content that they view on the device, which may diminish the revenue of entities offering content available to be accessed by mobile computing devices.

Such physical ailments may be limited when a user chooses to view content on a substantially stable mobile computing device, such as, but not limited to, a mobile computing device resting a stationary desk. Typically, a mobile computing device user has a more pleasurable experience viewing content on the device when the user's eyes can focus on the details of the content they are viewing and are not trying to follow the content in “playing catch-up” as the content is bouncing along with the ride of the vehicle. It would be advantageous to provide a similar stable-content experience to users of mobile computing devices that are traveling or are otherwise accessing content on an otherwise non-stationary mobile computing device.

Furthermore, multi-touch screens currently available on mobile computing devices typically require the use of two hands to operate the multi-touch screen. It would therefore also be advantageous to provide mobile computing device users similar functionality as current multi-touch screens, but enabling such functionality with a single hand.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

One embodiment of the invention may be characterized as a non-transitory, tangible computer readable storage medium, encoded with processor readable instructions to perform a method of changing a content display on a mobile computing device screen. The method includes operatively receiving a first signal, wherein the first signal comprises visual content, processing the first signal, and displaying at least a portion of the visual content on the mobile computing device screen. A second signal is also provided from at least one sensor. As the mobile computing device is moved a distance along at least one of a first axis, a second axis, and a third axis, the display of the at least a portion of the visual content on the mobile computing device screen is changed along the at least one of the first axis, the second axis, and the third axis relative to the movement of the mobile computing device.

Another embodiment of the invention may be characterized as a mobile computing device that includes a wireless receiver adapted to receive wireless content and further includes one or more motion detection sensors adapted to send a sensing signal to processing components. The processing components are operatively adapted to determine a distance and a direction that the device has moved and modify a display signal comprising the wireless content, sent to a mobile computing device display, the modification of the display signal being dependent upon the distance and the direction that the device has moved.

Yet another embodiment of the invention may be characterized as a mobile computing apparatus. The mobile computing apparatus in this embodiment includes means for detecting a direction and a distance of movement of a mobile computing device and means for changing a view of content displayed on a mobile computing device screen relative to the direction and distance movement of the mobile computing device, wherein, the content comprises at least one of remotely-accessed content and memory-accessed content.

And another embodiment of the invention may be characterized as a method of changing a display of content on a mobile computing device. One method in this embodiment comprises accessing at least one of remote content and memory content with the mobile computing device, displaying the at least one of remote content and memory content on a mobile computing device screen, moving the mobile computing device a first direction and a first distance, and changing the display of the at least one of remote content and memory content on the mobile computing device screen relative to moving the mobile computing device the first direction and the first distance.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, where like or similar elements are designated with identical reference numerals throughout the several views and wherein:

FIG. 1 illustrates a block diagram depicting processing components' inputs and output of an exemplary embodiment of the present invention;

FIG. 2 illustrates a block diagram depicting physical components of an exemplary embodiment of the present invention;

FIG. 3 is a flowchart that depicts a method that may be carried out in connection with the embodiments described herein;

FIGS. 4A-4C illustrate movement of a mobile computing device along an x-axis, y-axis, and z-axis, according to an exemplary embodiment of the present invention;

FIGS. 5A-5C′ illustrate a display of visual content on a mobile computing device relative to the movement of the mobile computing device along the x-axis, y-axis, and z-axis described with reference to FIGS. 4A-4C;

FIG. 6 illustrates movement of a view of content relative to a movement of a mobile computing device along an x-axis, y-axis, and z-axis described with reference to FIGS. 4A-4C.

### DETAILED DESCRIPTION

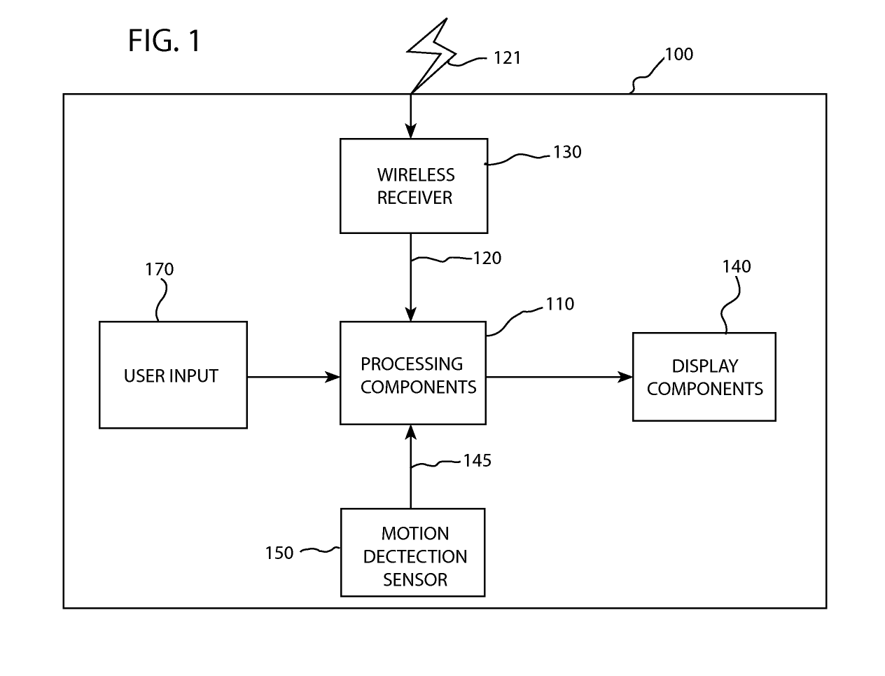

Referring first to FIG. 1, shown is a block diagram depicting inputs and an output of processing components 110 of an exemplary embodiment of a mobile computing device 100. In one embodiment, the processing components 110 may comprise one or more processors, memory devices, and associated electromechanical components including a non-transitory, tangible computer readable storage medium encoded with processor readable instructions. Such instructions comprise a method that, when executed, is adapted to change a display of visual content on a mobile computing device screen. In one embodiment, the method comprises operatively receiving a first signal 120, wherein the first signal comprises visual content. For example, in one embodiment the first signal 120 comprises a signal received at the processing components 110 from a mobile computing device wireless receiver 130. However, the first signal 120 may also comprise other signals such as, but not limited to a wireless signal 121 received by the wireless receiver 130 or a signal received from a mobile computing device memory location. The visual content may comprise a web page or may comprise other network-based documents or other documents stored on a local memory device such as, but not limited to an internal mobile computing device memory location or a memory card coupled to a memory card port in the mobile computing device 100.

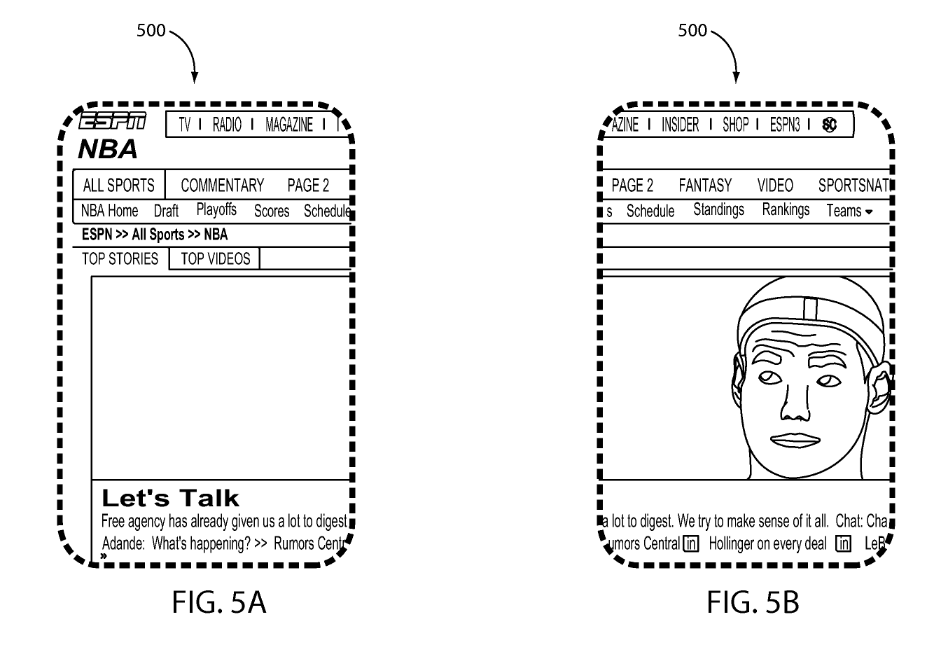

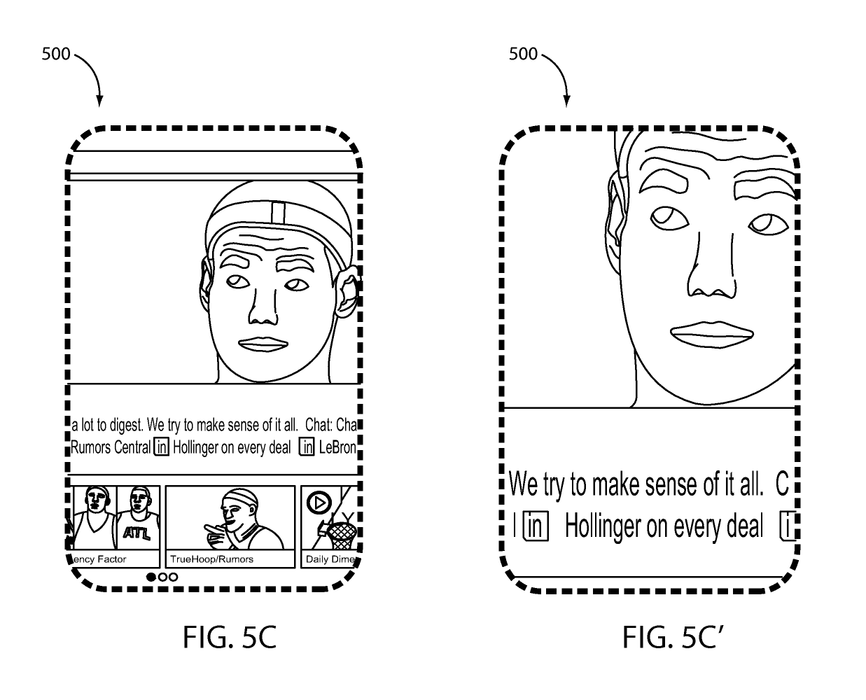

Upon receiving the first signal 120, the first signal 120 is processed by the processing components 110 and an output signal comprising at least a portion of the visual content is sent to, and for display on, display components 140 such as, but not limited to, a mobile computing device screen. The processing components 110 may crop and scale the visual content for display on the mobile computing device screen. FIG. 5A shows one display of cropped and scaled visual content on a mobile computing device screen. A second signal 145 is operatively provided from at least one sensor such 150 as, but not limited to, the motion detection sensor seen in FIG. 1, to the processing components 110, which process the second signal 145. In one embodiment, the second signal 145 comprises a signal from an on-board digital imaging device such as, but limited to, a digital camera.

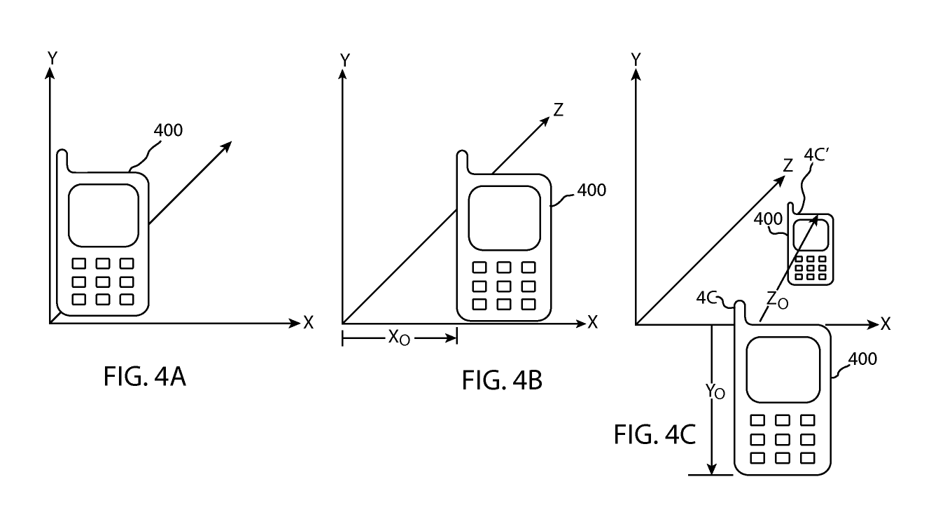

Upon displaying the visual content and receiving a signal from at least one sensor 150, in one embodiment, the mobile computing device 100 is then moved along at least one of a first axis, a second axis, and a third axis. For example, seen in FIGS. 4A, 4B, and 4C are illustrations of movement of a mobile computing device 400 along a first axis comprising an x-axis, a second axis comprising a y-axis, and a third axis comprising a z-axis. As the mobile computing device 400 is moved along the x-axis from the position seen in FIG. 4A to the position seen in FIG. 4B, along the y-axis from the position seen in FIG. 4B to the 4C position seen in FIG. 4C and along the z-axis from the 4C position to the 4C′ position in FIG. 4C, the display on the mobile computing device screen is modified. For example, seen in FIGS. 5A, 5B, and 5C is a display on a mobile computing device screen at each position 4A, 4B, and 4C, respectively.

As seen in one embodiment, moving the mobile computing device 400 along an axis such as along the x-axis from the FIG. 4A position to the FIG. 4B position changes the display of the at least a portion of the visual content on the mobile computing device screen along a substantially similar axis—here, the x-axis, as seen in FIG. 5A and FIG. 5B. Similarly, moving the mobile computing device 400 from along the y-axis from the FIG. 4B position to the 4C position in FIG. 4C changes the display of the at least a portion of the visual content on the mobile computing device screen along the y-axis from the FIG. 5B position to the FIG. 5C position, where the visual content y-axis is substantially similar to the mobile device y-axis. Furthermore, moving the mobile computing device 400 along the z-axis from the 4C position to the 4C′ position in FIG. 4C changes the display of the at least a portion of the visual content on the mobile computing device screen along the z-axis from the FIG. 5C position to the FIG. 5C′ position, where the visual content z-axis is substantially similar to the mobile device z-axis. As seen in FIGS. 5C and 5C′, one visual content z-axis may comprise a zoom-out or a zoom-in feature. For example, moving the mobile computing device 500 in a substantially forward direction away from a user as seen in FIG. 4C changes the display of the at least a portion of the visual content on the mobile computing device screen by zooming towards the at least a portion of the visual content on the mobile computing device screen. Similarly, moving the mobile computing device 500 in a substantially opposing, backward direction towards a user may change the display of the at least a portion of the visual content on the mobile computing device screen by zooming out from the at least a portion of the visual content on the mobile computing device screen.

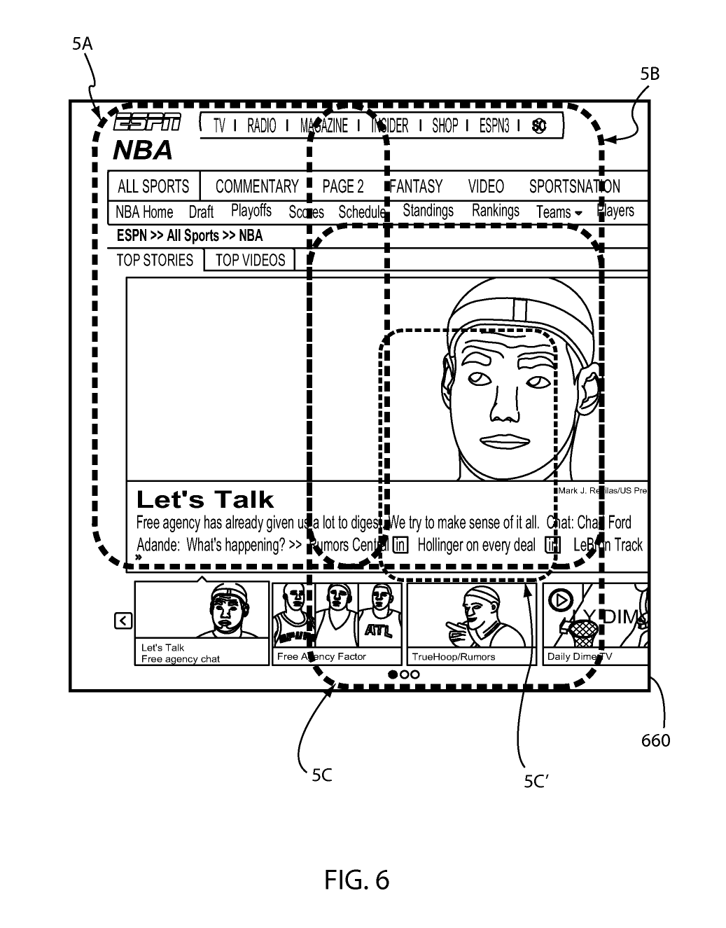

In order to correlate the movement of the mobile computing device 400, as seen in FIGS. 4A-4C to the movement of the visual content on the mobile computing device screen, as seen in FIGS. 5A-5C′, the distance and direction that the mobile computing device 400 has moved is correlated to a distance and direction on the visual content on the mobile computing device screen. For example, distances X₀, Y₀, and Z₀ and the directions X, Y, and Z seen in FIGS. 4A-4C are correlated to distances X₁, Y₁, and Z₁, in the X, Y and Z directions, respectively, on the mobile computing device screen seen in FIG. 6. The X₀, Y₀, and Z₀ distances may comprise a first device distance, second device distance, and third device distance, respectively, while the X₁, Y₁, and Z₁ distances may comprise a first content distance, second content distance, and third content distance, respectively.

In one embodiment, correlating mobile computing device 400 movement to content movement is performed by first determining each distance the device has moved in a particular direction. For example, in one embodiment, the motion detection sensor 150 as seen in FIG. 1, such as, but not limited to, a mobile computing device camera, provides a plurality of images to the processing components 110. The processing components 110 may be adapted to process the images and determine distances X₀, Y₀, and Z₀ for each movement of the mobile computing device along the X, Y, and Z axis. Furthermore, the processing components 110 may also be adapted to correlate mobile computing device 100 distances X₀, Y₀, and Z₀ to visual content distances X₁, Y₁, and Z₁, respectively. In one embodiment, the length of distances X₁, Y₁, and Z₁, is dependent on the length of distances X₀, Y₀, and Z₀, respectively, as well as the size, resolution, and scaling of the visual content 660 as seen in FIG. 6 on the mobile computing devices screen, amongst other factors. Upon determining the distance and direction of X₁, Y₁, and Z₁, the display on the mobile computing device screen is changed after each movement of the mobile computing device 400. In one embodiment, changing the display of the at least a portion of the visual content on the mobile computing device screen each of the X₁, Y₁, and Z₁ distances, respectively, occurs at generally the same time as moving the mobile computing device the X₀, Y₀, and Z₀ distances, respectively.

In changing the display of the at least a portion of the visual content on the mobile computing device screen along the x-axis, y-axis, and z-axis, one embodiment may comprise sliding the display of the at least a portion of the visual content on the mobile computing device screen along the x-axis, y-axis, and z-axis the X₁, Y₁, and Z₁ distances, respectfully. For example, in one embodiment, a user of the mobile computing device 400 may access visual content 660 such as, but not limited to the web page seen in FIG. 6, a portion of which may be initially displayed on the mobile computing device screen as seen in FIG. 5A. The portion of visual content 660 displayed on the mobile computing device screen in FIG. 5A is shown in FIG. 6. Similarly, the portion of the visual content displayed on the mobile computing device screen in FIGS. 5A, 5B, 5C and 5C′ are also seen in FIG. 6.

Upon accessing the visual content 660, if the user of the mobile computing device wishes to view one or more additional portions of the visual content 660, the user may then move the mobile computing device side-to-side along the x-axis and/or up-and-down along the y-axis. Such movement may cause the visual content 660 to slide across the screen. For example, in moving the mobile computing device 400 from the FIG. 4A position to the FIG. 4B position, the visual content 660 seen in FIG. 6 on the mobile computing device screen may appear to slide in an opposing x-axis direction, as if the mobile computing device 400 is a “window” through which the user may view the content. For example, as the mobile computing device 400 moves right from the position in FIG. 4A to the position in 4B, as seen in FIGS. 5A and 5B, the visual content of FIG. 6 appears to “slide” to the left a distance X₁. Similar movements occur along the Y-axis—in moving the mobile computing device the Y₀ distance, seen in FIG. 4C, the visual content 660 appears to move up a corresponding Y₁ distance. Pushing the mobile computing device forward the Z₀ distance seen in FIG. 4C zooms into the portion of the content the user is viewing, a distance Z₁. It is to be appreciated that although directions and distances described herein occur along the x-axis, y-axis, and z-axis, mobile device movements may occur which are not along these axis, but are between the axis describe herein. In such instances, the processing components 110 seen in FIG. 1 may move the visual content a similar between-axis direction and distance corresponding to the between-axis direction and distance that the mobile device has moved.

As seen in FIG. 1, an embodiment may also be comprised of user input 170. User input 170 may be comprised of user preferences stored in the processing components 110. For example, the user input 170 may comprise selections made by the user in one of firmware and software adapted to be accessed by the processing components upon enablement of a display modification mode in order to modify the visual content display. In one embodiment, the user input 170 also comprises a display modification mode enablement device where a user may enable the visual content display modification disclosed herein through depressing a button on the mobile computing device, or through, for example, choosing an on-screen software selection. Upon enabling the display modification mode, when the user moves the mobile device 100, the visual content displayed on the mobile computing device screen is modified as described herein. The user may disable the display modification by releasing the button, or in a different manner such as, but not limited to, performing an on-screen software selection.

Some user preferences stored in the processing components 110 may include selections chosen by the user in order to accommodate a certain usage environment. For example, a user may enable one or more of a low-light mode and an indoor/outdoor mode when a camera is used as the sensor 150. Additionally, different motion modes may be enabled through choosing certain user preference selections. For example, a user may choose a “still” device mode or may choose a “walking” device mode or a device “vehicle” mode. Each mode or each user preference selection may change the algorithm that the processing components 110 employ to output a signal to the display components 140. For example, choosing between a walking mode and a vehicle mode may change how the algorithm adjusts for movement of the mobile computing device 100 so that the algorithm takes into account the peripheral movement of the user and/or vehicle, diminishing the likelihood of a user's eyes becoming tired in viewing the content on the device 100. Other modifications may be made to the processing of the second signal 145 in order to provide an optimal display of the visual content. For example, in certain instances, a user may choose to select a “power saving” mode for optimal performance or a user may choose an “auto” mode which enables an automatic selection of certain user preferences. One embodiment may automatically switch between user preference selections such as, but not limited to, between a walking mode and a vehicle mode, based on information received by the processing components 100.

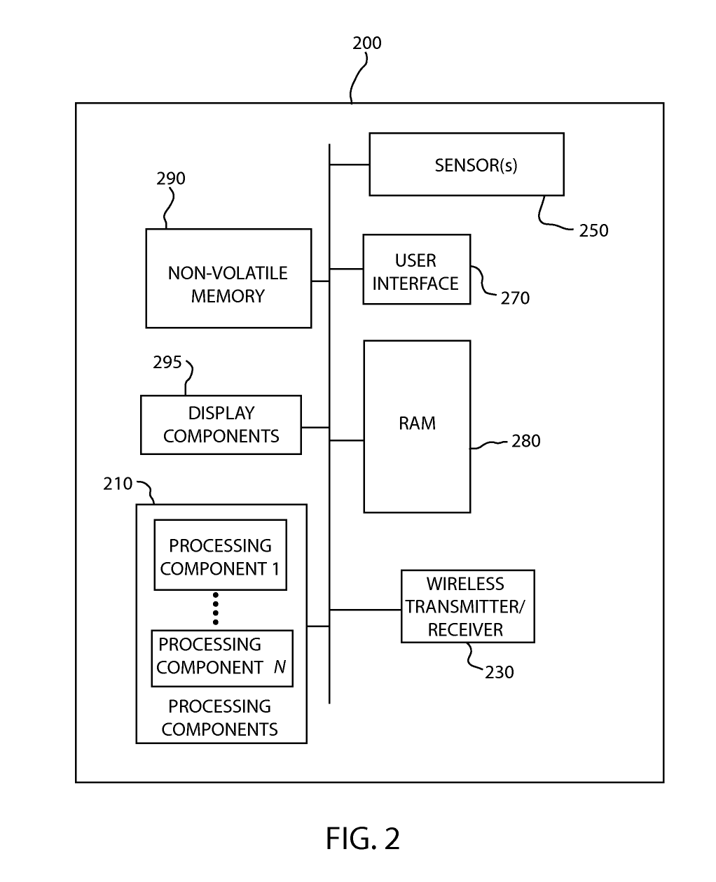

Turning now to FIG. 2, shown is a block diagram depicting physical components of an exemplary embodiment of the present invention. One embodiment comprises a mobile computing device 200 comprising a wireless receiver 230 that may also comprise a transmitter and is adapted to receive and transmit wireless content. The mobile computing device 200 may also comprise one or more sensors 250 such as, but not limited to, a digital camera and an accelerometer. The sensors 250 are adapted to send a motion detection sensing signal to processing components 210 upon detection that the mobile computing device 200 has moved. The processing components 210, which may comprise one or more of software, firmware and electromechanical hardware components, are operatively adapted to process the signal from the sensor and, upon movement of the mobile computing device 200, determine a distance and a direction that the mobile computing device 200 has moved, and subsequently modify a display.

For example, the processing components 210 may process a plurality of digital images sent from a digital camera sensor 250 to detect a direction and a distance of movement of the mobile computing device 200. The mobile computing device 200 also comprises one or more memory components including RAM 280 and non-volatile memory (NVM) 290, as well as display components 295 such as, but not limited to, a display screen. The processing components 210 may access the RAM and NVM in order to obtain at least one of firmware and software comprising instructions for processing signals from the sensor(s) 250 and for processing content received from the wireless receiver 230, as well as to process data received from a user interface 270. The user interface 270 may also be referred to as a user input comprising user preference information. One user interface 270 such as, but not limited to, a mobile computing device button, may be adapted to enable and disable one or more motion detection sensors. In receiving a signal comprising visual content from the wireless receiver 230 (such as, a web page) or a memory device (such as, locally-stored digital photographs) and sending a display signal comprising the visual content to the display components 295, the processing components 210 may subsequently modify the display signal dependent upon the distance and the direction that the mobile computing device has moved as described above with reference to FIGS. 4A-6. Alternatively, or in conjunction with receiving the signal from the wireless receiver, a signal comprising content may also be received from the RAM 280 or a memory card. The display of remotely accessed content and/or memory-accessed content may be adjusted utilizing an algorithm to crop and scale the content so that the content may be displayed on a mobile computing device screen.

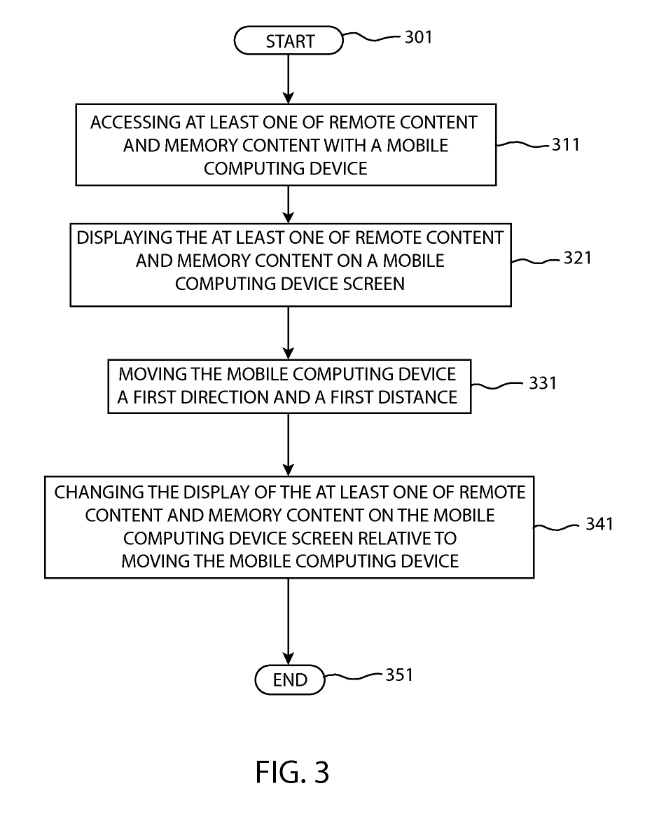

In turning now to FIG. 3, seen a flowchart that depicts a method that may be carried out in connection with the embodiments described with reference to FIGS. 1, 2, and 4A-6. One embodiment is a method of changing a display of content on a mobile computing device 100 which starts at 301 and comprises, at 311, accessing at least one of remote content and memory content with the mobile computing device 100. For example, the mobile computing device 100 may access a remotely hosted web page through the mobile computing device wireless receiver/transmitter, or may access a digital file located in an on-board memory component or a coupled memory component such as, but not limited, to, a memory card. At 321, the method further comprises displaying the at least one of the remote content and the memory content on a mobile computing device screen. At 331, the method comprises subsequently moving the mobile computing device 100 a first device direction and a first device distance. In one embodiment, the first device direction may be the X direction seen in FIGS. 4A and 4B and the first device distance may be the X₀ distance. The mobile computing device 400 may move from a first mobile computing device position seen in FIG. 4A to a second mobile computing device position seen in FIG. 4B. At 341, the display of the at least one of remote content and memory content is changed on the mobile computing device screen relative to moving the mobile computing device 400 the first direction and the first distance. For example, the display on the mobile computing device 400 may be changed from a first content position as seen in FIG. 5A to a second content position as seen in FIG. 5B. As seen in FIG. 6, the second content position may be located a first content distance X₁ from the first content position. Additionally, the first content direction, X, may also be dependent upon the second device position.

In conclusion, embodiments of the present invention enable a mobile communicating device to modify the view of content displayed on the mobile computing device through movement of the mobile computing device. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A non-transitory, tangible computer readable storage medium, encoded with processor readable instructions to perform a method of changing a content display on a mobile computing device screen, the method comprising,
operatively receiving a first signal, wherein the first signal comprises visual content;
processing the first signal;
displaying at least a portion of the visual content on the mobile computing device screen;
providing a second signal from at least one sensor;
moving the mobile computing device along at least one of a first axis, a second axis, and a third axis;
processing the second signal; and
changing the display of the at least a portion of the visual content on the mobile computing device screen, wherein,
moving the mobile computing device along the first axis changes the display of the at least a portion of the visual content on the mobile computing device screen along the first axis,
moving the mobile computing device along the second axis changes the display of the at least a portion of the visual content on the mobile computing device screen along the second axis, and
moving the mobile computing device along the third axis changes the display of the at least a portion of the visual content on the mobile computing device screen along the third axis.

2. The non-transitory, tangible computer readable storage medium of claim 1 wherein, the visual content comprises a web page accessed via a wireless connection.

3. The non-transitory, tangible computer readable storage medium of claim 1 wherein displaying at least a portion of the visual content on the mobile computing device screen comprises displaying a cropped and scaled web page on the mobile computing device screen.

4. The non-transitory, tangible computer readable storage medium of claim 1 wherein, the first axis comprises one of a substantially horizontal left-right direction and a substantially horizontal forward-backward direction.

5. The non-transitory, tangible computer readable storage medium of claim 4 wherein, the third axis comprises the other of a substantially horizontal left-right direction and a substantially horizontal forward-backward direction.

6. The non-transitory, tangible computer readable storage medium of claim 5 wherein,
moving the mobile computing device in a substantially forward direction changes the display of the at least a portion of the visual content on the mobile computing device screen by one of zooming towards and away from the at least a portion of the visual content on the mobile computing device screen; and
moving the mobile computing device in a substantially backward direction changes the display of the at least a portion of the visual content on the mobile computing device screen by the other of zooming towards and away from the at least a portion of the visual content on the mobile computing device screen.

7. The non-transitory, tangible computer readable storage medium of claim 1 wherein,
moving the mobile computing device along the first axis changes the display of the at least a portion of the visual content on the mobile computing device screen along the first axis comprises,
determining a first device distance that the mobile computing device has moved along the first axis,
corresponding the distance that the mobile computing device has moved in the first axis to a first content distance on the visual content, and
changing the display of the at least a portion of the visual content on the mobile computing device screen along the first axis the first content distance;
moving the mobile computing device along the second axis changes the display of the at least a portion of the visual content on the mobile computing device screen along the second axis comprises,
determining a second device distance that the mobile computing device has moved along the second axis,
corresponding the second device distance that the mobile computing device has moved in the second axis to a second content distance on the content, and
changing the display of the at least a portion of the visual content on the mobile computing device screen along the second axis the second content distance;
moving the mobile computing device along the third axis changes the display of the at least a portion of the visual content on the mobile computing device screen along the third axis comprises,
determining a third device distance that the mobile computing device has moved along the third axis,
corresponding the third device distance that the mobile computing device has moved along the third axis to a third content distance on the visual content, and
changing the display of the at least a portion of the visual content on the mobile computing device screen along the third axis the third content distance.

8. The non-transitory, tangible computer readable storage medium of claim 7 wherein,
the first axis comprises a horizontal x-axis;
the second axis comprises a vertical y-axis;
the third axis comprises a horizontal z-axis;
changing the display of the at least a portion of the visual content on the mobile computing device screen along the first axis the first content distance occurs at generally the same time as moving the mobile computing device the first device distance;
changing the display of the at least a portion of the visual content on the mobile computing device screen along the second axis the second content distance occurs at generally the same time as moving the mobile computing device the second content distance; and
changing the display of the at least a portion of the visual content on the mobile computing device screen along the third axis the third content distance occurs at generally the same time as moving the mobile computing device the third content distance.

9. The non-transitory, tangible computer readable storage medium of claim 7 wherein,
changing the display of the at least a portion of the visual content on the mobile computing device screen along the first axis the first content distance comprises sliding the display of the at least a portion of the visual content on the mobile computing device screen along the first content distance;
changing the display of the at least a portion of the visual content on the mobile computing device screen along the second axis the second content distance comprises sliding the display of the at least a portion of the visual content on the mobile computing device screen along the second content distance; and
changing the display of the at least a portion of the visual content on the mobile computing device screen along the third axis the third content distance comprises sliding the display of the at least a portion of the visual content on the mobile computing device screen along the third content distance.

10. The non-transitory, tangible computer readable storage medium of claim 1 wherein, providing a second signal from at least one sensor comprises providing a signal from a mobile computing device camera.

11. The non-transitory, tangible computer readable storage medium of claim 1 further comprising, selecting a display modification mode after the displaying at least a portion of the visual content on a mobile computing device screen.

12. The non-transitory, tangible computer readable storage medium of claim 11 wherein, selecting a display modification mode comprises enabling the changing of the display of the at least a portion of the visual content on the mobile computing device screen through at least one of depressing a button on the mobile computing device and choosing an on-screen selection.

13. A mobile computing device, comprising:
a wireless receiver adapted to receive wireless content;
one or more motion detection sensors adapted to send a sensing signal to processing components; wherein,
the processing components are operatively adapted to,
determine a distance and a direction that the mobile computing device has moved, and
modify a display signal comprising the wireless content dependent upon the distance and the direction that the mobile computing device has moved.

14. The mobile computing device of claim 13 further comprising, a user input mechanism adapted to enable and disable the one or more motion detection sensors.

15. The mobile computing device of claim 13 further comprising one or more memory components comprising processor instructions.

16. The mobile computing device of claim 15, wherein, the one or more memory components further comprises user preference information.

17. The mobile computing device of claim 13 wherein the one or more motion detection sensors comprises at least one of a camera and an accelerometer.

18. The mobile computing device of claim 13 wherein, the processing components are further adapted to process a succession of images.

19. A mobile computing apparatus comprising,
means for detecting a direction and a distance of movement of a mobile computing device;
means for changing a view of content displayed on a mobile computing device screen relative to the direction and distance movement of the mobile computing device, wherein, the content comprises at least one of,
remotely-accessed content, and
memory-accessed content.

20. The mobile computing apparatus of claim 19 wherein, the means for detecting movement of a mobile computing device comprises processing images from a mobile computing device camera.

21. The mobile computing apparatus of claim 19 wherein, the means for changing a view of content displayed on a mobile computing device relative to the direction and distance of the mobile computing device comprises a processor adapted to utilize an algorithm to crop and scale the content so that the content may be displayed on a mobile computing device screen.

22. A method of changing a display of content on a mobile computing device comprising,
accessing at least one of remote content and memory content with the mobile computing device;
displaying the at least one of the remote content and memory content on a mobile computing device screen;
moving the mobile computing device a first device direction and a first device distance; and
changing the display of the at least one of remote content and memory content on the mobile computing device screen relative to moving the mobile computing device the first device direction and the first device distance.

23. The method of claim 21 wherein,
moving the mobile computing device a first device direction and a first device distance comprises moving the mobile computing from a first device position to a second device position; and
changing the display of the at least one of remote content and memory content on the mobile computing device screen relative to moving the mobile computing device the first device direction and first device distance comprises changing the display from a first content position to a second content position, the second content position comprising,
a first content distance from the first content position, the first content distance being dependent on the second device position, and
a first content direction from the first content position, the first content direction being dependent upon the second device position.
